(19) United States
(12) Patent Application Publication
(10) Pub. No.: US 2020/0401381 A1
(43) Pub. Date: Dec. 24, 2020

(54) VIRTUAL REALITY BASED COMPUTER APPLICATION DEVELOPMENT

(71) Applicant: INTERNATIONAL BUSINESS MACHINES CORPORATION, Armonk, NY (US)

(72) Inventors: AUSTIN CARTER, Olmstead, MN (US); GUNNAR MILLS, Rochester, MN (US); John R. Dangler, Rochester, MN (US); Colin Edward MASTERSON, Rochester, MN (US)

(21) Appl. No.: 16/445,626

(22) Filed: Jun. 19, 2019

(51) Int. Cl. G06F 8/34; G06F 11/36; G06T 19/20

(52) U.S. Cl. CPC G06F 8/34; G06T 19/20; G06F 11/3664; G06F 11/364

(57) ABSTRACT

A computer-implemented method includes receiving, by an integrated development environment (IDE), a stack trace that comprises a plurality of function calls, the IDE is initiated in a 3-dimensional (3D) virtual reality environment for analyzing a computer application. The method further includes accessing, by the IDE, a first source-code file that includes a first function call from the stack trace, and accessing a second source-code file that includes a second function call from the stack trace, the second function call being inside a first function corresponding to the first function call. The method further includes displaying, by the IDE, in the 3D virtual reality environment a first representation of the first source-code file, a second representation of the second source-code file, and a link between the first representation and the second representation.

### BACKGROUND

The present invention generally relates to computer technology, and more specifically, to virtual reality-based improvements computer application development, such as during compiling and debugging computer code for the computer application.

In general, integrated development environments (IDEs) are powerful programming toolkits that integrate editors, wizards, compilers, debuggers, and other tools, which enable software developers to build complex programs and applications. Conventional IDE systems and programming toolkits can employ functions and other resources to assist developers in designing and implementing application code.

### SUMMARY

According to one or more embodiments of the present invention, a computer-implemented method includes initiating, by a code development system, an integrated development environment (IDE) in a 3-dimensional (3D) virtual reality environment for analyzing a computer application. The method further includes receiving, by the IDE, a stack trace that comprises a plurality of function calls. The method further includes opening, by the IDE, a first source-code file that includes a first function call from the stack trace, and opening a second source-code file that includes a second function call from the stack trace, the second function call being inside a first function corresponding to the first function call. The method further includes displaying, by the IDE, in the 3D virtual reality environment a first representation of the first source-code file, a second representation of the second source-code file, and a link between the first representation and the second representation.

According to one or more embodiments of the present invention, a system includes a memory, and a processor coupled to the memory. The processor performs a method for analyzing source code of a computer application. The method includes initiating, by a code development system, an integrated development environment (IDE) in a 3-dimensional (3D) virtual reality environment for analyzing a computer application. The method further includes receiving, by the IDE, a stack trace that comprises a plurality of function calls. The method further includes opening, by the IDE, a first source-code file that includes a first function call from the stack trace, and opening a second source-code file that includes a second function call from the stack trace, the second function call being inside a first function corresponding to the first function call. The method further includes displaying, by the IDE, in the 3D virtual reality environment a first representation of the first source-code file, a second representation of the second source-code file, and a link between the first representation and the second representation.

According to one or more embodiments of the present invention, a computer program product includes a computer readable storage medium that has program instructions embodied therewith. The program instructions are executable by a processing circuit to cause the processing circuit to perform a method to analyze source code of a computer application. The method includes initiating, by a code development system, an integrated development environment (IDE) in a 3-dimensional (3D) virtual reality environment for analyzing a computer application. The method further includes receiving, by the IDE, a stack trace that comprises a plurality of function calls. The method further includes opening, by the IDE, a first source-code file that includes a first function call from the stack trace, and opening a second source-code file that includes a second function call from the stack trace, the second function call being inside a first function corresponding to the first function call. The method further includes displaying, by the IDE, in the 3D virtual reality environment a first representation of the first source-code file, a second representation of the second source-code file, and a link between the first representation and the second representation.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 depicts a block diagram of a system for software development collaboration according to one or more embodiments of the present invention;

FIG. 4 illustrates an example computer;

FIG. 5 depicts a visualization of a stack trace according to one or more embodiments of the present invention;

FIG. 6 depicts a block diagram of hardware and source code interaction according to one or more embodiments; and

FIG. 7 depicts a flowchart of a method for developing a computer application according to one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Traditionally, developing code for large projects for computer application development (software development) can be difficult due to the abstraction of linking, code hierarchy, and limited screen space to display various artifacts used in the computer application development environment. Nearly all software and hardware developers work with some form of code that involves multiple documents, source files, and references that become very cumbersome to manage on a limited computer monitor space. This abstract linking also makes it difficult to maintain and co-develop the code as any relevant information must be found by reading through the documentation, instructed by the original author, or an exhaustive review of the source code itself. The one or more embodiments of the present invention facilitate developers with an intuitive, interactive debugging environment that de-abstracts the code.

One or more embodiments of the present invention are rooted in computing technology, particularly software development. One or more embodiments of the present invention improve existing solutions of compiling and debugging tools available for computer application development. Existing solutions do not give developers a virtual reality-based system that can provide developers a visual linking 3-dimensional (3D) view of a stack trace. One or more embodiments of the present invention further facilitate understanding and debugging unknown code. One or more embodiments of the present invention further facilitate debugging different languages and mixed language support. Another advantage of one or more embodiments of the present invention is that they improve the speed of debugging because of the use of the 3D environment. One or more embodiments of the present invention provide technical solutions to at least such technical challenges and further advantages provided will be evident from the description that follows. The one or more embodiments described herein accordingly improve at least computer application development tools and facilitate improvements in computer rooted technology.

One or more embodiments of the present invention facilitate, during software development and maintenance, visualization of code errors and stack traces. Further, one or more embodiments of the present invention facilitate visualizing links in one or more code portions and following the links for debugging the code. One or more embodiments of the present invention also facilitate improvements to team-based code development. Such improvements are facilitated by one or more embodiments of the present invention because by using virtual reality-based system, screen space is not limited to the monitors (displays) used during the code development.

In addition to software code development, one or more embodiments of the present invention facilitate improvements to hardware creation and design (e.g. when using Hardware Description Language (HDL)). In addition to the above advantages associated with source code, one or more embodiments of the present invention facilitate visualizing entities and functions physically in a 3D space, for example, of hardware components being programmed/developed. Further, links and wires of the hardware components being developed can be physically followed by the eye in virtual reality simulated environment. For example, during printed circuit board (PCB) design, the one or more components of the PCB can be visualized in 3D and routed substantially simultaneously using one or more embodiments of the present invention.

One or more embodiments of the present invention can be implemented using a cloud-based computing system. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

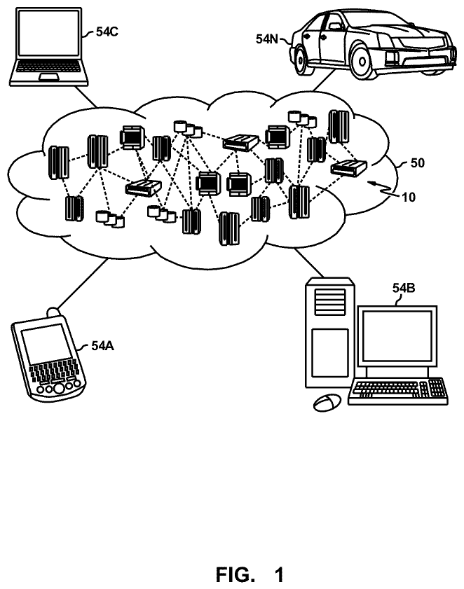

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

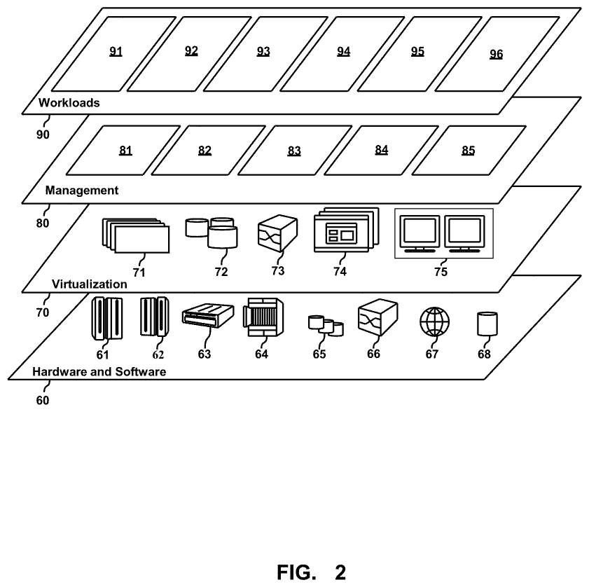

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and providing virtual reality base source code development environment 96.

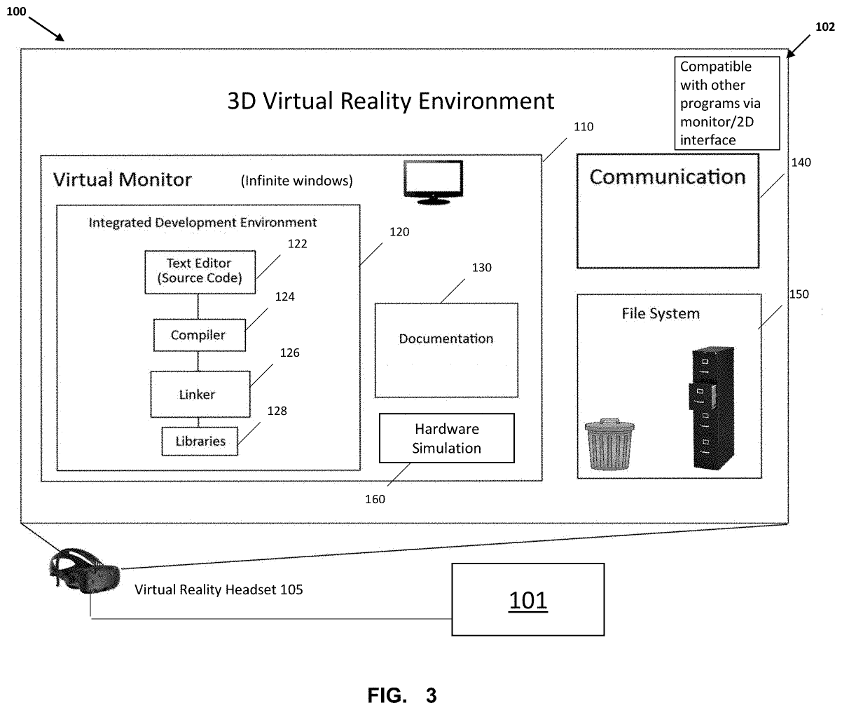

FIG. 3 depicts a block diagram of a system for virtual reality-based computer application development according to one or more embodiments of the present invention. A computer application development system 100 (henceforth referred to as development system 100) can include a virtual reality headset 105 that accesses data from a computer 101 and present to a user a 3D virtual reality environment 102 (henceforth referred to as VRE 102). The VRE 102 includes, among other components, a virtual monitor 110, a communication device 120, and a file system 150. These components are simulations of corresponding physical counterparts, for example, the virtual monitor 110 is instead of a physical display unit, the communication device 120 is instead of a desk-phone (or mobile and the like), and the file system 150 is instead of a physical cabinet. Other such virtualized physical components/systems can be displayed in the VRE 102.

Further, the VRE 102 includes a hardware simulation 160 window. The hardware simulation 160 displays a model, for example, a 3D model, of a hardware component that is associated with the source code being developed. In one or more examples, the hardware component can be a PCB, or any other hardware component. The source code can be HDL or any other programming language in such cases. The hardware simulation 160 displays the model of the hardware component and in one or more examples, a particular part/portion/component of the model is marked/highlighted corresponding to the source code being interacted with by the developer in the IDE 120, for example in the text editor 122.

The virtualized components in the VRE 102 are interactive. That is, the developer can interact with the virtualized components and access data represented by the components. For example, the developer can communicate with the communication device 120 as if s/he is interacting with a desk phone (or mobile) at an office desk. Similarly, the developer can interact with the file system 150 to place and remove files to be accessed. Further yet, the virtual monitor 110 facilitates the developer to interact with data for the computer application being developed.

For example, the virtual monitor 110 presents to the developer an IDE 120 and a documentation system 130. The documentation system 130 can provide one or more documents associated with the source code and other parts of the computer application that is being developed. The IDE 120 can include a text editor 122, a compiler 124, a linker 126, and one or more libraries 128. The IDE 120, using these components, facilitates the developer to edit source code (e.g. in the text editor 122) and compile and link it with the one or more libraries 128 to create an executable computer application. In one or more examples, the IDE 120 can also be used to debug the source code that is being written using the components. It should be noted that the IDE 120 can include various other components that are not depicted or described herein.

The computer application being developed in the IDE 120 can include various instructions of the source code that can include function calls and various other features that are provided by the computer programming language being used. It should be noted that the IDE 120 is not limited to any particular computer programming language.

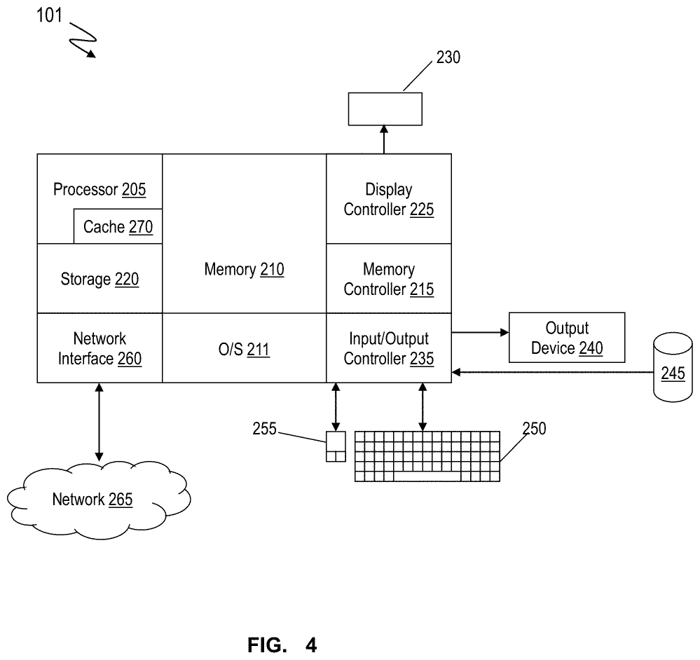

FIG. 4 illustrates an example computer. The computer 101 may be a communication apparatus, such as a desktop computer, a tablet computer, a laptop computer, a phone, such as a smartphone, a server computer, or any other device that communicates via a network 265.

The system 101 includes, among other components, a processor 205, memory 210 coupled to a memory controller 215, and one or more input devices 245 and/or output devices 240, such as peripheral or control devices, that are communicatively coupled via a local I/O controller 235. These devices 240 and 245 may include, for example, battery sensors, position sensors, indicator/identification lights and the like. Input devices such as a conventional keyboard 250 and mouse 255 may be coupled to the I/O controller 235. The I/O controller 235 may be, for example, one or more buses or other wired or wireless connections, as are known in the art. The I/O controller 235 may have additional elements, which are omitted for simplicity, such as controllers, buffers (caches), drivers, repeaters, and receivers, to enable communications.

The I/O devices 240, 245 may further include devices that communicate both inputs and outputs, for instance disk and tape storage, a network interface card (MC) or modulator/demodulator (for accessing other files, devices, systems, or a network), a radio frequency (RF) or other transceiver, a telephonic interface, a bridge, a router, and the like.

The processor 205 is a hardware device for executing hardware instructions or software, particularly those stored in memory 210. The processor 205 may be a custom made or commercially available processor, a central processing unit (CPU), an auxiliary processor among several processors associated with the system 100, a semiconductor based microprocessor (in the form of a microchip or chip set), a macroprocessor, or other device for executing instructions. The processor 205 includes a cache 270, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 270 may be organized as a hierarchy of more cache levels (L1, L2, and so on.).

The memory 210 may include one or combinations of volatile memory elements (for example, random access memory, RAM, such as DRAM, SRAM, SDRAM) and nonvolatile memory elements (for example, ROM, erasable programmable read only memory (EPROM), electronically erasable programmable read only memory (EEPROM), programmable read only memory (PROM), tape, compact disc read only memory (CD-ROM), disk, diskette, cartridge, cassette or the like). Moreover, the memory 210 may incorporate electronic, magnetic, optical, or other types of storage media. Note that the memory 210 may have a distributed architecture, where various components are situated remote from one another but may be accessed by the processor 205.

The instructions in memory 210 may include one or more separate programs, each of which comprises an ordered listing of executable instructions for implementing logical functions. In the example of FIG. 2, the instructions in the memory 210 include a suitable operating system (OS) 211. The operating system 211 essentially may control the execution of other computer programs and provides scheduling, input-output control, file and data management, memory management, and communication control and related services.

Additional data, including, for example, instructions for the processor 205 or other retrievable information, may be stored in storage 220, which may be a storage device such as a hard disk drive or solid state drive. The stored instructions in memory 210 or in storage 220 may include those enabling the processor to execute one or more aspects of the systems and methods described herein.

The system 101 may further include a display controller 225 coupled to a user interface or display 230. In some embodiments, the display 230 may be an LCD screen. In other embodiments, the display 230 may include a plurality of LED status lights. Alternatively, or in addition, the display 230 can include the virtual reality headset 105. In some embodiments, the system 101 may further include a network interface 260 for coupling to a network 265. The network 265 may be an IP-based network for communication between the system 101 and an external server, client and the like via a broadband connection. In an embodiment, the network 265 may be a satellite network. The network 265 transmits and receives data between the system 101 and external systems. In some embodiments, the network 265 may be a managed IP network administered by a service provider. The network 265 may be implemented in a wireless fashion, for example, using wireless protocols and technologies, such as WiFi, WiMax, satellite, or any other. The network 265 may also be a packet-switched network such as a local area network, wide area network, metropolitan area network, the Internet, or other similar type of network environment. The network 265 may be a fixed wireless network, a wireless local area network (LAN), a wireless wide area network (WAN) a personal area network (PAN), a virtual private network (VPN), intranet or other suitable network system and may include equipment for receiving and transmitting signals.

Each time the computer application performs a function call, information about the call is generated. That information generally includes the location of the call in the application, the arguments of the call, and the local variables of the function being called. The information is stored in a block of data called a stack frame. Stack frames are allocated in a region of memory called the call stack. The call stack is divided into contiguous pieces called stack frames or, simply, frames. Each frame includes the data associated with one call to one function. The frame contains the arguments given to the function, the function's local variables, and the address at which the function is executing. The concept of the stack frame is well known to those of skill in the art.

When the computer application is started, the stack includes an initial frame associated with the main function call of the application—typically named “main.” Each time a function is called, a new frame is created. Each time a function returns, the frame for that function invocation is removed. The frame being executed at a particular time is called the innermost frame. This is the most recently created of all the stack frames that still exist.

A stack trace (sometimes referred to as a “backtrace”) is a summary of how an application reached a particular state in terms of various functions being called. A stack trace generally shows one line of text per stack frame, starting with the currently executing frame (frame N), followed by frame N's caller (frame N−1), and so on up the stack. The execution of a complex software application can generate a stack trace that contains tens or even hundreds of stack frames. It can be tedious and time-consuming for a user (e.g., a software developer or system administrator) to navigate such a large, complex stack trace and to use the stack trace to help analyze the application.

One or more embodiments of the present invention facilitate increasing the productivity and understanding of developing and debugging software/hardware using the IDE 120 displayed via the VR headset 105.

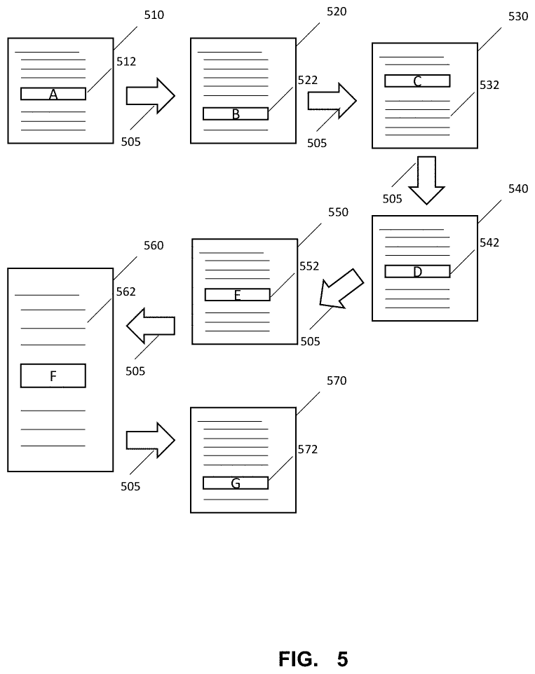

FIG. 5 depicts a visualization of a stack trace according to one or more embodiments of the present invention. The example visualization in FIG. 5 shows a stack trace 500. Because the VRE 102 offer a substantially infinite screen real estate, and at least, much larger display space compared to a 2D monitor, the displayed stack trace 500 by the IDE 120 includes each file in the stack trace 500. For example, in the depicted example, the stack trace includes a chain of function calls A (512)>B (522)>C (532)>D (542)>E (552)>F (562)>G (572). It is understood that in other examples the chain of function calls can have a different number of function calls. Each of these function calls is depicted to be respective source code files—file 510, file 520, file 530, file 540, file 550, file 560, and file 570, collectively referred to as source code files.

The IDE 120 opens and displays each of the source code files. Further, in each opened file, the IDE 120 identifies the source code line(s) that include the function call from the stack trace. The identification can include highlighting the line(s) of code, for example by changing the background attribute and/or the foreground attribute. For example, the background attribute can include color, transparency, border etc. For example, the foreground attributes can include, font, color etc. Further, the visualization of the stack trace includes a link 505 between each file that is opened. The links 505 collectively indicates the sequence of the chain of function calls. Each link 505 connects two files in the stack trace indicating the next file that includes the next function call in the chain. For example, the link 505 between the file 510 and the file 520 indicates that the function A from the file 510 calls the function B from the file 520.

In one or more examples, the source code files are represented as thumbnails (510, 520, 530, 540, 550, 560, and 570). The developer can interact with a thumbnail (for example, click) and in response the corresponding source code file is opened in the text editor 122 for the developer to review and/or edit. The source code file is opened in the text editor 122 with the source code line(s) corresponding to the function call being identified. For example, if the developer requests opening the file 520, the text editor 122 displays the source code from the file 520 with the function B (522) identified.

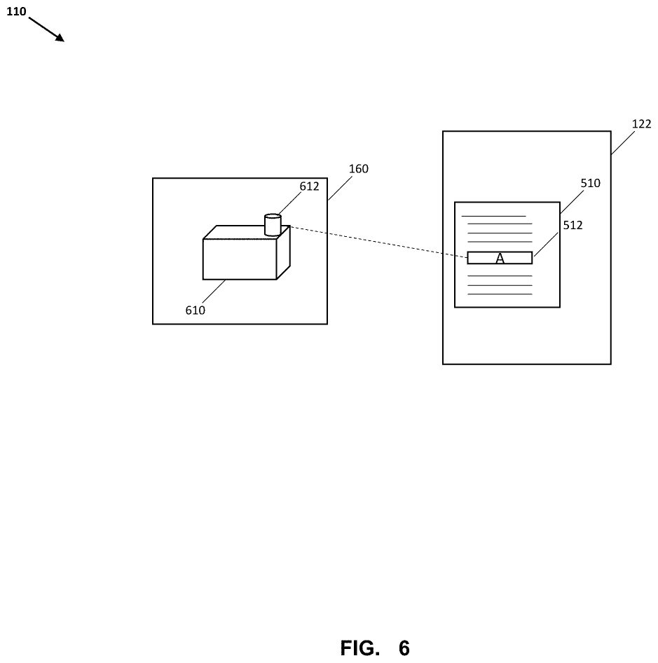

FIG. 6 depicts a block diagram of hardware and source code interaction according to one or more embodiments. In this case, a hardware component 610 is associated with the source code being developed using the development system 100. Accordingly, a simulation of the hardware component is performed and a model of the hardware component 610 is depicted in the hardware simulation 160 window. In one or more examples, a part 612 of the hardware component 610 is highlighted because the developer is interacting with source code corresponding to the part 612. For example, if the developer selects the first file 510 for editing/analyzing, and if the function A 512 is associated with the part 612, both, the function A 512 in the first file 510 and the corresponding part 612 in the model 610 are marked.

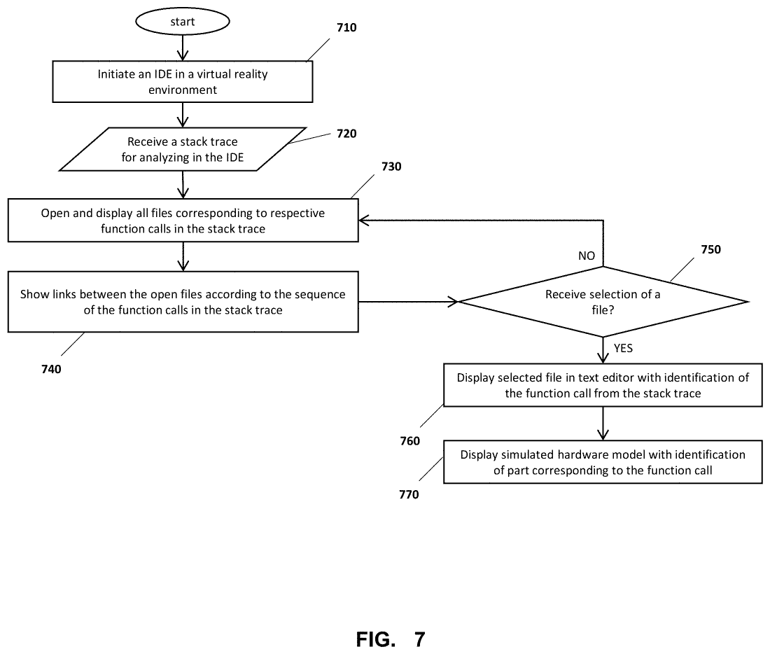

FIG. 7 depicts a flowchart of a method for developing a computer application according to one or more embodiments of the present invention. The method includes initiating the IDE 120 in the VRE 102 for developing a computer application, at 710. The computer application includes multiple source code files. In one or more examples, the source code is associated with hardware component(s).

The method further includes receiving a stack trace for analysis, at 720. In one or more examples, the stack trace can be generated and received in response to the developer requesting a debug operation or some other operation that causes the stack trace to be generated. Generation of stack trace is performed using commonly known techniques using operations such as parsing, compilation, linking, etc. The stack trace includes a chain of function calls that is multiple function calls. The function calls can each be in respective source code files. It should be noted that the libraries 128 can be part of the source code files. In one or more examples, the development is already being performed in the IDE 120 using the 3D environment, and in such cases, the stack trace is already present in the IDE 120. As such, “receiving” the stack trace can include generating the stack trace based on the source code files being used in the IDE 120.

The method further includes opening and displaying all the source code files corresponding to respective function calls in the stack trace, at 730. For example, the first source code file 510 corresponding to the function A 512 and the second source code file 520 corresponding to the function B 522, and all other source code files for the function calls in the stack trace are opened and displayed. Further yet, links between all the opened files are shown according to the sequence of the function calls in the stack trace, at 740.

If the developer selects a file from the displayed collection of linked files, the selected file is shown in the text editor 122, at 750 and 760. In one or more examples, the text editor 122 identifies the portion/lines in the source code file that contain(s) the function call from the stack trace. For example, if the first source code file 510 is selected, the function A 512 is marked in the text editor 122.

Further, in case a hardware component 610 is associated with the first source code file the hardware component 610 is displayed in the hardware simulation 160, at 770. Further yet, if the part 612 of the hardware component 610 corresponds to the function call A 512, the part 612 is marked in the hardware simulation 160 to show the correspondence between the function call A 512 and the part 612.

It should be noted that in one or more embodiments of the present invention hardware simulation 160 of the hardware component 610 and/or the debugging using the stack trace in the 3D environment are performed separately. Accordingly, in one or more embodiments of the present invention, the hardware simulation 160 and the debugging using the stack trace in the 3D environment can be performed using separate respective systems by different users, and at different time points in the development.

Accordingly, one or more embodiments of the present invention facilitate a practical application, and furthermore, an improvement to computer rooted technology, where the IDE and other development tools for a computer application (software/hardware) are improved by providing developers an efficient way to analyze source code and corresponding hardware components. Accordingly, one or more embodiments of the present invention increase the productivity and understanding of developing and debugging software/hardware. One or more embodiments of the present invention also make interacting with the source code much more intuitive and natural by using the virtual reality environment than the standard Monitor/Mouse/Keyboard approach.

The virtual reality environment provides a virtual office environment that includes virtual representations of software or programs that a user (developer) interacts with at a typical office desk. Further yet, by using the virtual reality environment, one or more embodiments of the present invention, improve features of IDEs such as syntax checking and “Go To Declaration” linking by enabling keeping two or more files open substantially. Because space is not an issue in a 3D virtual reality environment, in one or more examples, a separate window is created for each file in a stack trace and explicitly (a line or other indicator) shown to where the call is made in the caller and called function. Accordingly, the developer can view all relevant files in a comprehensible manner and interact with those that s/he needs to analyze/edit further.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source-code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
receiving, by an integrated development environment (IDE), a stack trace that comprises a plurality of function calls, the IDE is initiated in a 3-dimensional (3D) virtual reality environment for analyzing a computer application;
accessing, by the IDE, a first source-code file that includes a first function call from the stack trace;
accessing, by the IDE, a second source-code file that includes a second function call from the stack trace, the second function call being inside a first function corresponding to the first function call; and
displaying, by the IDE, in the 3D virtual reality environment a first representation of the first source-code file, a second representation of the second source-code file, and a link between the first representation and the second representation, wherein the stack trace includes a chain of functions calls, each function call is displayed to be respective source code files and source code lines corresponding to the function calls are identified in the respective source code files by highlighting the source code lines.

2. The computer-implemented method of claim 1, further comprising:
receiving, by the IDE, a selection of the first source-code file;
in response, displaying, by the IDE, a text editor with the first source-code file.

3. The computer-implemented method of claim 2, wherein a portion of the first source-code file with the first function call is identified.

4. The computer-implemented method of claim 1, further comprising:
displaying, simultaneously, by the IDE, a simulation of a hardware component associated with the computer application.

5. The computer-implemented method of claim 4, wherein a portion of the hardware component is highlighted corresponding to the first source-code file in response to selection of the first source-code file.

6. The computer-implemented method of claim 5, wherein the IDE is viewed via a virtual reality headset.

7. The computer-implemented method of claim 1, wherein the virtual reality environment further displays a documentation window with documentation for the computer application.

8. A system comprising:
a memory; and
a processor coupled to the memory, the processor configured to perform a method for analyzing source code of a computer application, the method comprising:
receiving, by an integrated development environment (IDE), a stack trace that comprises a plurality of function calls, the IDE operating in a 3-dimensional (3D) virtual reality environment;
accessing, by the IDE, a first source-code file that includes a first function call from the stack trace;
accessing, by the IDE, a second source-code file that includes a second function call from the stack trace, the second function call being inside a first function corresponding to the first function call; and
displaying, by the IDE, in the 3D virtual reality environment a first representation of the first source-code file, a second representation of the second source-code file, and a link between the first representation and the second representation, wherein the stack trace includes a chain of functions calls, each function call is displayed to be respective source code files and source code lines corresponding to the function calls are identified in the respective source code files by highlighting the source code lines.

9. The system of claim 8, wherein the method further comprises:
receiving, by the IDE, a selection of the first source-code file;
in response, displaying, by the IDE, a text editor with the first source-code file.

10. The system of claim 9, wherein a portion of the first source-code file with the first function call is identified.

11. The system of claim 8, wherein the method further comprises:
displaying, simultaneously, by the IDE, a simulation of a hardware component associated with the computer application.

12. The system of claim 11, wherein a portion of the hardware component is highlighted corresponding to the first source-code file in response to selection of the first source-code file.

13. The system of claim 12, wherein the IDE is viewed via a virtual reality headset.

14. The system of claim 8, wherein the virtual reality environment further displays a documentation window with documentation for the computer application.

15. A computer program product comprising a computer readable storage medium having program instructions embodied therewith, the program instructions executable by a processing circuit to cause the processing circuit to perform a method to analyze source code of a computer application, the method comprising:
receiving, by an integrated development environment (IDE), a stack trace that comprises a plurality of function calls, the IDE operating in a 3-dimensional (3D) virtual reality environment;
accessing, by the IDE, a first source-code file that includes a first function call from the stack trace;
accessing, by the IDE, a second source-code file that includes a second function call from the stack trace, the second function call being inside a first function corresponding to the first function call; and
displaying, by the IDE, in the 3D virtual reality environment a first representation of the first source-code file, a second representation of the second source-code file, and a link between the first representation and the second representation, wherein the stack trace includes a chain of functions calls, each function call is displayed to be respective source code files and source code lines corresponding to the function calls are identified in the respective source code files by highlighting the source code lines.

16. The computer program product of claim 15, wherein the method further comprises:
receiving, by the IDE, a selection of the first source-code file;
in response, displaying, by the IDE, a text editor with the first source-code file.

17. The computer program product of claim 16, wherein a portion of the first source-code file with the first function call is identified.

18. The computer program product of claim 15, wherein the method further comprises:
displaying, simultaneously, by the IDE, a simulation of a hardware component associated with the computer application.

19. The computer program product of claim 18, wherein a portion of the hardware component is highlighted corresponding to the first source-code file in response to selection of the first source-code file.

20. The computer program product of claim 19, wherein the IDE is viewed via a virtual reality headset.
